(19) United States
(12) Patent Application Publication
(10) Pub. No.: US 2026/0106056 A1
(43) Pub. Date: Apr. 16, 2026

(54) Lead Forming Device for Forming an Electronic Component Lead and a Method for Forming an Electronic Component Lead

(71) Applicant: Besi Netherlands B.V., Duiven (NL)

(72) Inventor: Robertus Christina Johannes Maria Schoenaker, Duiven (NL)

(21) Appl. No.: 19/116,417

(22) PCT Filed: Sep. 26, 2023
(86) PCT No.: PCT/NL2023/050502

§ 371 Date: Mar. 28, 2025

(30) Foreign Application Priority Data
Sep. 30, 2022 (NL) 2033194

(51) Int. Cl. H01B 13/00

(52) U.S. Cl. CPC H01B 13/0036

(57) ABSTRACT

The invention relates to a lead forming device for forming an electronic component lead, including two cooperating opposite tool parts relatively movable towards and away from each other; a first clamp half attached to one of the tool parts and a second clamp half attached to the opposite tool part for clamping at least part of the lead. The invention also relates to a method for forming an electronic component lead, including the steps: a) providing an electronic component including at least one lead; b) clamping the at least one lead on opposite sides of the lead at a clamping location adjacent to the electronic component and away from a tip of the lead; and c) bending the lead in a first bending direction at a first bending location.

### CROSS-REFERENCE TO RELATED APPLICATIONS

This application is the United States national phase of International Patent Application No. PCT/NL2023/050502 filed Sep. 26, 2023, and claims priority to The Netherlands Patent Application No. 2033194 filed Sep. 30, 2022, the disclosures of which are hereby incorporated by reference in their entireties.

### BACKGROUND OF THE INVENTION

### Field of the Invention

The present invention relates to a lead forming device for forming an electronic component lead, a lead forming assembly comprising such a lead forming device, use of the lead forming device and the lead forming assembly, and a method for forming an electronic component lead.

A lead of an electronic component is a thin layer of metal for connecting the wiring from the electronic component with the circuitry of a larger scale circuitry of e.g. electrical devices and circuit boards. Electronic components, such as chips or integrated circuits often have plural leads which are used to mount the electronic components. Leads in the form of wire are also called pins. Throughout this document, when the term “lead” is used, it refers to longitudinal leads normally in the form of a wire or a thin layer of metal.

### Description of Related Art

Electronic components having leads are often manufactured such that they are initially encapsulated while the leads still project from one or more sides of the moulded electronic component as straight, linear elements. In this phase at least part of the leads may still be fixed to a further part of a lead frame. To individualise (separate) the electronic component from the further part of the lead frame, the leads have to be cut. This cutting of leads is also referred to as “trimming”. Trimming results in leads at one end being attached to the electronic component, while the opposite ends of the leads are not attached to the lead frame anymore so they have a free end (also referred to as the tip of the lead).

Prior to mounting, the freed leads may also be bent for instance in the form of a ‘J’ or an ‘S’. An “S-shape lead” is—as it more or less has a shape of the wing of a gull—also referred to as a gullwing shaped lead. When an electronic component, provided with gullwing leads, is placed on a mounting surface it rests on these leads. Each lead may extend outward from the electronic component to deflect downward towards the mounting surface. The sideward deflecting part of the lead adjacent to the electronic component is referred to as the shoulder part of the lead. Further outwards and adjacent to the shoulder part of a gullwing shaped lead is the heel part of the lead. And the tip or outer end of the lead, the part that is preferably approximately parallel to the mounting surface, is referred to as the toe part of the lead. The toe part of the lead is suited to be attached, e.g. via soldering, to a mounting surface.

Trimming and forming of the leads may be executed as subsequent operations, but it is also possible to—at least partly—combine trimming and forming. In practice, trimming and forming occurs within a single—combined—device. A carrier comprising a matrix of electronic components is fed via a transporter to a trim and form device that initially trims one or more rows of leads. Subsequently, the carrier is moved so that a trimmed row of leads arrives at a forming section of the trim and form device and a further row of leads, preferably neighbouring a trimmed row of leads is trimmed, while the already trimmed leads at the forming section are bent into a desired shape. After being processed in the trim and form device the electronic components with individualized and bent leads leaves the trim and form device. Such a trim and form process may take place at high speed; trimming and forming a group of leads may be achieved within less than a fraction of a second.

Trim and form devices are known in the art and may comprise an upper tool part, a lower tool part, and a guide element for holding and relatively guiding the tool parts. The tool parts are movable towards and away from each other. One or more punches may be attached to at least one of the tool parts and may extend through a guide plate. Also, a die may be mounted to one of the tool parts, such that an electronic component may be placed in between the tool parts such that its leads extend above one or more cavities of the die. The cavities may have a shape complementary to an outer surface of the punch. Upon operation, the leads are clamped in place. Subsequently a punch moves into a cavity of the die held while the lead resides between punch and cavity. The complementary shapes of the interacting surfaces of punch and die determine the resulting shape of the lead.

Leads of electronic components are often coated with a surface coating to improve conductivity and other electrical and physical characteristics of lead that enable a better and/or more reliable attachment of the leads. Such a coating may be a thin metal layer of palladium, tin, or another suited metal or alloy. Such a thin metal surface coating is fragile and prone to break or release during trimming and/or forming. A punch may contact a coated lead and push it into a corresponding cavity, a process that is also referred to as bending. Due to contacting the coated leads and exerting a force on the leads, one side of the lead may be stretched, while an opposite side the lead may be compressed. Such local stretching and compressing of leads may create shear forces in the coating of the leads which may result in the formation of micro cracks in the coating of the leads. In addition, during the forming process, part of the lead coating may be scraped off the lead. Apart from the coating, also the leads themselves and even the electronic component may be damaged by bending the leads. Coating coming loose from the leads may also collect in cavities of the die, thereby polluting the cavities and necessitating regular cleaning of the trim and form device.

### SUMMARY OF THE INVENTION

There is thus a need for a lead forming device and a forming method that enables fast and accurate forming of wire leads, while preventing or at least limiting the chance of damaging leads or a coating thereon.

In a first aspect, the present invention provides for this purpose a lead forming device for forming an electronic component lead, comprising: two cooperating opposite tool parts relatively movable towards and away from each other; a first clamp half attached to one of the tool parts and a second clamp half attached to the opposite tool part for clamping at least part of the lead; at least one first forming punch movably connected to one of the tool parts and at least one second forming punch movably connected to the opposite tool part; and a drive arranged for independently controlling cooperative movement of the first and second forming punches.

It was found that by providing at least one first forming punch and at least one second forming punch, the total force required to punch and form the leads is distributed over two punch strikes instead of one. As such, a maximum force exerted on the lead is reduced, as the drive independently controls cooperative movement of the at least one second forming punch and the at least one first forming punch. Damage to a surface coating present on top of the electronic component is reduced as compared to standard lead forming devices, wherein use is made of a single punch to form the leads. In addition, making use of two forming punches instead of one, enhances the accuracy of forming the lead. The shape of the lead produced with the lead forming device as set out above, is thus closer to the desired shape, as compared to state-of-the-art lead forming devices.

Preferably, the at least one first forming punch and the at least one second forming punch are configured to consecutively bend the electronic component lead while the lead remains clamped by the first clamp half and the second clamp half. This allows bending of the electronic component lead to be split up in multiple steps, without having to move the electronic component to another location in the same device, or to another device altogether, to perform the subsequent bending step. As such, the maximum force, or peak force applied on the lead is reduced, while a negligible amount of processing time is lost.

As disclosed herein, a forming punch is distinct from a clamp half, and also distinct from a die. Forming punches are configured to form a lead. This means that a forming punch is capable of transforming a lead from one shape to another, in particular by bending the lead. The forming, as such, is capable of contacting the lead and moving it a certain direction, and as such transforming the shape of the lead. Forming punches can cooperate with dies, but this is not required per se.

Clamps, clamp halves, and dies are capable of contacting a lead, but are not capable of deforming a lead on their own, without the aid of cooperating forming punches.

The first clamp half may be movably attached to one of the tool parts and/or the second clamp half may be movably attached to the opposite tool part. This allows additional freedom in moving the clamp halves with respect to the first and second forming punch.

Therefore, control over the forming process of the leads is enhanced, resulting in a more accurately formed lead.

Preferably, the at least one first forming punch is relatively movable towards and away from the at least one second forming punch. This allows the punches to act on the leads one after the other, effectively distributing the total force required for forming the lead over multiple punch strikes.

The at least one first forming punch may be arranged to bend at least part of a lead in one single direction; and the at least one second forming punch may be arranged to bend at least a part of the lead in one second opposite direction. As such, no punch bends the lead in multiple directions. This effectively ensures that each punch strike results in a single bend in a single direction, instead of one punch strike bending the lead in multiple directions. Bending a lead in one direction with a single punch strike requires less force as compared to bending a lead in multiple directions with a single punch strike. Moreover, shear forces are effectively reduced when a lead is bent with multiple punch strikes, wherein each punch strike results in a single bend of the lead, instead of a single punch strike resulting in multiple bends of the lead.

In an embodiment, the at least one first forming punch may be located adjacent to the first clamp half, and the at least one second forming punch may be located adjacent to the second clamp half. This allows the lead to remain clamped, while being shaped or formed by the subsequent action of the at least one first forming punch and the at least one second forming punch. Due to the at least one forming punch being located adjacent to the first clamp half and the at least one second forming punch being located adjacent to the second clamp half, as outlined in this exemplary embodiment, both clamp halves and both forming punches are located close together, in a single device, obviating the necessity to transfer the electronic component, and the leads connected thereto, to a different location in between the forming of the lead by the at least one first forming punch and the at least one second forming punch. As a result, processing speed of lead forming is increased, while peak forces applied on the leads are lowered.

In another embodiment, the at least one first forming punch may comprise at least two forming punches located adjacent to each other. Advantageously, this allows a lead to be bent at least three times while remaining clamped. As such, the processing time is further reduced. This is particularly advantageous when at least one of the first forming punch and/or the second forming punch comprises a surface allowing the lead to be bent around by another one of the at least one first forming punch or the at least one second forming punch, as this allows the forming punches to first act as a forming punch, and thereafter act as a die for a subsequent forming action by another forming punch.

In line with the above, one forming punch of the at least two forming punches may have a first side located adjacent to the first clamp half and a second opposite side located adjacent to another forming punch of the at least two forming punches. Advantageously, this allows the forming punches to be aligned along the length wherein the lead extends, allowing the lead to be effectively bent by the subsequent action of the forming punches.

Preferably, the first and second clamp halves are movable in a direction substantially parallel to a direction of cooperative movement of the first and second forming punches. When the clamp halves clamp a lead, this lead is supported on two opposing sides of the lead. When either the first or second forming punch moves in a direction substantially parallel to the clamp halves towards the unclamped part of the lead and initiates bending of the lead, the lead will be supported fully by the clamp half towards which the lead is bent. The configuration as described above, wherein the first and second clamp halves are movable in a direction substantially parallel to a direction of cooperative movement of the first and second forming punches, is advantageous, as it ensures bending of the lead is performed in a stable manner. The risk of the lead slipping from the clamp, formed by both clamp halves, is thus minimized. If a lead is for example clamped from a top and an opposite bottom of the lead surface, it is advantageous to strike this clamped lead in a similar or same direction wherein it is clamped (i.e. from the top or the bottom). As such, the lead bends in a direction towards the top or bottom by the punch strike, while the remainder of the lead remains securely clamped, maximizing the effectiveness of the forming process. In a preferred embodiment, the at least one first forming punch comprises a convex bending surface and the at least one second forming punch comprises a concave bending surface or the other wat around. In operation, a side of the convex bending surface of the first forming punch, closest to either clamp half, contacts an unclamped part of the lead and bends it towards one of the clamp halves while the first forming punch moves to a terminal position. Subsequently, the second forming punch moves towards the first forming punch and thus towards the unclamped and bent part of the lead. The second forming punch now moves this part of the lead back around the convex bending surface of the first forming punch. This allows effective forming of the lead in a gullwing shape in two subsequent punch strikes. Preferably, the convex bending surface of the first forming punch is complementary to the concave bending surface of the second forming punch.

The lead forming device may comprise at least one trimming punch for trimming the lead. The leads have to be cut from the lead frame and trimmed to size. This allows the lead to have a desired length that is beneficial when the lead is mounted to a substrate. Advantageously, up and down movement of a part of the lead forming device can be used simultaneously for both trimming and forming.

In another embodiment, the lead forming device comprises at least one third forming punch movably attached to one of the tool parts for bending the lead. Advantageously, this allows the forming of the lead to be separated into even more subsequent punch strikes. As such, the total force enacted upon a lead per punch strike is lowered even further. As a result, the lead and coating are even less likely to be damaged due to lead forming. It is for example conceivable that a first forming punch bends a lead in a first direction, and a second forming punch bends this lead in a second opposite direction while the first forming punch remains in position after bending the lead in the first direction. Thereafter, the lead can be clamped by two other clamp halves and a third forming punch could bend the lead even further in the first direction, such that a gullwing shape lead is formed. This ensures that a foot of the gullwing shaped lead from the heel to the toe is substantially parallel to an upper and lower surface of the electronic component that is attached to the lead. This in turn allows effective mounting of the electronic component via the feet of the leads.

Preferably, the first clamp half and the second clamp half each comprise an at least partially flat lead contacting surface. This ensures that a total surface area of contact surfaces between the lead and both clamp halves are enlarged. As a consequence, frictional forces between the clamp halves and the lead are enlarged. The result is that the lead is more securely held in place throughout the forming and/or trimming process, which in turn improves the accuracy of forming the lead in the desired shape.

At least one of the first clamp half and the second clamp half may be arranged to at least partially form the lead. When a punch strikes a part of a lead adjacent to a location where this lead is clamped, the lead can be formed by not only the punch, but also the first and/or second clamp half. This can for example be realized by one of the first clamp half and the second clamp half having a partly rounded or sloped surface at a location where the lead is to be formed, adjacent to a location where the lead is clamped. In operation, a forming punch may be able to form the lead by punching the lead against such a clamp half surface.

Preferably, the first clamp half and the second clamp half are provided with multiple contact surfaces for clamping multiple leads. This allows forming time required per lead to be drastically reduced, as multiple leads can be bent with a single strike. In line therewith the first and/or second forming punches may be provided with multiple contact surfaces to bend multiple leads.

In an embodiment, the first clamp half and the second clamp half may be arranged to directly contact at least part of the electric component lead. Directly contacting is herein defined as contacting without any intermediate objects present. A clamp half directly contacting at least part of the electric component lead for example does not clamp the lead via intermediate electronic components. As such, no clamping pressure is exerted on parts of the electronic component other than the leads, which prevents accidental damage to the electronic component.

At least part of a lead clamping surface of the second clamp half may be located opposite at least part of the first forming punch forming a die-like surface and another at least part of the lead clamping surface of the second clamp half may be located opposite at least part of the first clamp half forming a clamp-like surface; and the die-like surface and the clamp-like surface may not be located in a same plane. Likewise, a reversed configuration is possible, wherein at least part of a lead clamping surface of the first clamp half may be located opposite at least part of the second forming punch forming a die-like surface and another at least part of the lead clamping surface of the first clamp half may be located opposite at least part of the second clamp half forming a clamp-like surface; and the die-like surface and the clamp-like surface may not be located in a same plane.

Advantageously, this enables the lead to be at least partially bent around the die-like surface of a clamp half as the die-like surface and the clamp like surface are not located in the same plane, but are for example, arranged in planes that are arranged in an angle with respect to each other. A clamp half can as such have a dual function, acting both as a die for the action of at least one forming punch, and as a clamp half for clamping an electric component lead.

In a second aspect, the present invention is directed to a lead forming assembly comprising a lead forming device according to the present invention, wherein the lead forming device comprises: a lead trimming lead and/or preforming section, comprising an upper trimming clamp half movably attached to the first tool part, a lower trimming clamp half movably attached to the second tool part, and the third trimming punch; a lead forming section, comprising the first and second clamp halves and the at least one first and at least one second forming punches; and a final forming section, comprising an upper final forming clamp movably attached to the first tool part, a lower final forming clamp movably attached to the second tool part, and the at least one third forming punch. This assembly allows to fist trim the leads, thereafter form the leads, and finally push the formed leads in a desired direction. Effectively, a total force required to form the leads is distributed over at least three steps. As a consequence, a maximal force enacted on the leads at any one time is reduced, and damage to the leads, surface coatings, and electronic components, is reduced or even fully prevented. The incorporation of a lead trimming lead and/or preforming section, a lead forming section, and a final forming section in one assembly allows for high-speed trimming and forming of leads as well.

In a third aspect, the present invention is directed to a use of a lead forming device according to the present invention or a lead forming assembly according to the present invention, for forming at least one electronic component lead.

In a fourth aspect, the present invention is directed to a method for forming an electronic component lead, comprising the following steps: a) providing an electronic component comprising at least one lead; b) clamping the at least one lead on opposite sides of the lead at a clamping location adjacent to the electronic component and away from a tip of the lead; c) bending the lead in a first direction at a first bending location located between the clamping location and the tip of the lead; and d) bending the lead in a second direction at a second bending location between the first bending location and the tip; wherein steps c) and d) are performed subsequently. Therewith bending of the lead is divided over steps c) and d). Each bend formed in the lead requires less force as bending of the lead in both the first and the second direction at the same time would. This results in reduction or prevention of damage to the lead, surface coating, and electronic component.

Preferably, the first bending direction is opposite the second bending direction. This effectively ensures that the lead is first bent in a single direction, instead of simultaneously bending the lead in multiple directions. Bending a lead in one direction requires less force as compared to bending a lead in multiple directions at once. Moreover, shear forces are effectively reduced with multiple consecutive bends, resulting in a damage reduction or prevention of the leads, electronic component and surface coating.

Alternatively, or additionally, steps c) and d) are performed subsequently while the lead remains in a clamped position. This effectively reduces the time required to form the lead into, e.g. a gullwing shape. As multiple bending steps can be performed while using the same clamp halves, the processed leads do not have to proceed to the following forming location after only bending the lead once.

Preferably, prior to step b) the lead is cut. This facilitates forming of the lead to a desired length and shape, such as a gullwing shape.

After step d) the at least one lead may be further bent in the first bending direction. This effectively splits bending of the lead in the first direction into two separate steps. As a consequence, total force exerted on the lead at any single time is further reduced, leading to the advantages as stated hereinabove.

Preferably, during step c) the at least one lead is bent around at least part of a surface of at least one clamp half clamping the at least one lead together with another clamp half at the clamping location. Advantageously, this allows the lead to be partially shaped by the at least one clamp half. The clamp half can act like a stop for a punch, such that the lead is engaged by the punch and part of the clamp half simultaneously over a given length of the lead.

During step d) the lead may be bent around at least part of a surface of a punch bending the at least one lead in the first bending direction at the first bending location. At least a part of the surface of the at least one punch that bends the lead in the first bending direction may have such a shape that it allows bending of the lead back around this surface towards the punch. In this way, the punch acts as a die that is punched by another punch, thereby shaping the lead.

### BRIEF DESCRIPTION OF THE DRAWINGS

The terms Fig., Figs., Figure, and Figures are used interchangeably to refer to the corresponding figures in the drawings.

The present invention will be further elucidated on the basis of the non-limitative exemplary embodiments shown in the following figures. Herein shows:

FIG. 1 a cross sectional side view of a part of a prior art lead forming device;

FIGS. 2A and 2B cross sectional side views of a part of the lead forming device of the present invention in different positions; and

FIG. 3 a cross sectional view of a lead forming device according to the present invention.

### DESCRIPTION OF THE INVENTION

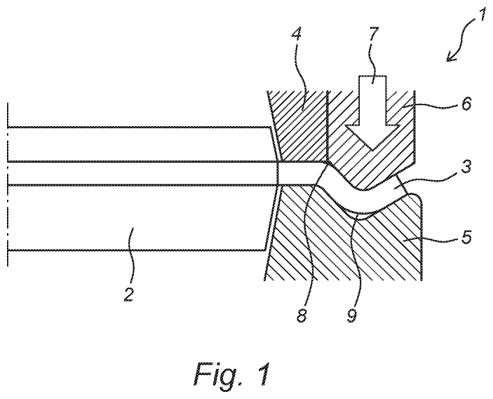

FIG. 1 shows a part of a prior art lead forming device 1 with a part of an electronic component 2 and a wire lead 3 extending from the electronic component 2. The lead 3 is clamped between a first clamp half 4 and part of a die 5. The lead 3 is formed with the use of a first forming punch 6 that has been moved downward, indicated by the arrow 7. The force exerted by the second forming punch 6 has bent the lead 3 at the shoulder 8 position and at the heel 9 position. As the lead 3 requires bending at the shoulder 8 and the heel 9, a relatively large downward force is required for the first forming punch 6 to push the lead 3 into the die 5.

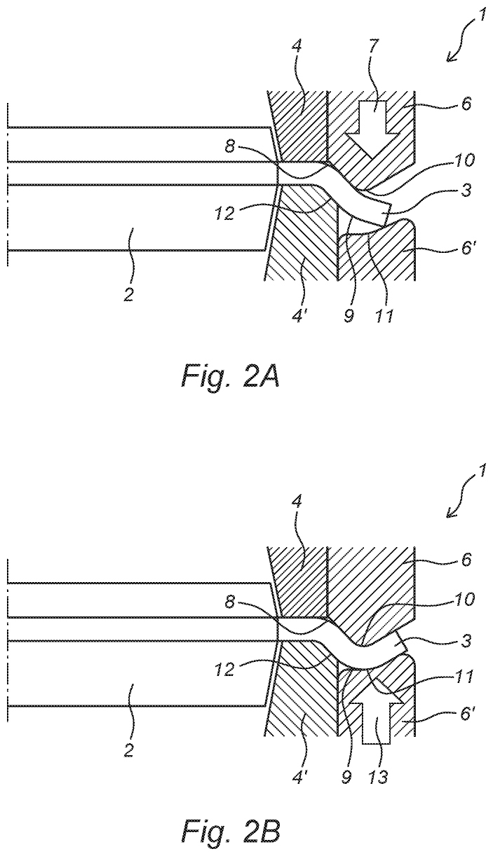

FIG. 2A shows a part of a lead forming device 1 according to the present invention in a first position, with a part of an electronic component 2 and a wire lead 3 extending from the electronic component 2. The lead 3 is clamped between a first clamp half 4 and a second clamp half 4′. The lead 3 is partially formed with the use of a first forming punch 6 that has been moved downward, indicated by the first arrow 7. The force exerted by the first forming punch 6, having a convex surface 10, has bent the lead 3 at the shoulder 8 position and has partially bent the lead 3 at the heel 9 position. As the lead 3 is bent primarily at the shoulder position 8, a relatively small downward force is required for the first forming punch 6 to bend the lead 3 towards the second forming punch 6′. The second forming punch 6′has a concave surface 11 and acts partly as a die for the first forming punch 6 at this stage. In this first position, the heel 9 has not yet completely been formed and is shaped around a sloped surface 12 of the second clamp half 4′to prevent the lead 3 from bending too far in the direction of the first arrow 7.

FIG. 2B shows the same part of a lead forming device 1 according to the present invention as FIG. 2A does, albeit in a second position. In this second position, the lead 3 has been bent back around a convex surface 10 of the first forming punch 6 in the direction of the second arrow 13 by the second forming punch 6. The complementary concave surface 11 of the second forming punch 6′ensures that the heel 9 forms completely.

The force required to bend the lead 3 in the direction of the arrow 7 and partly forming the shoulder 8, as shown in FIG. 2A, and the force required to bend the lead 3 upward and forming the heel 9, as shown in FIG. 2B are both smaller than the force required to partly form the shoulder 8 and the heel 9 simultaneously, as shown in FIG. 1.

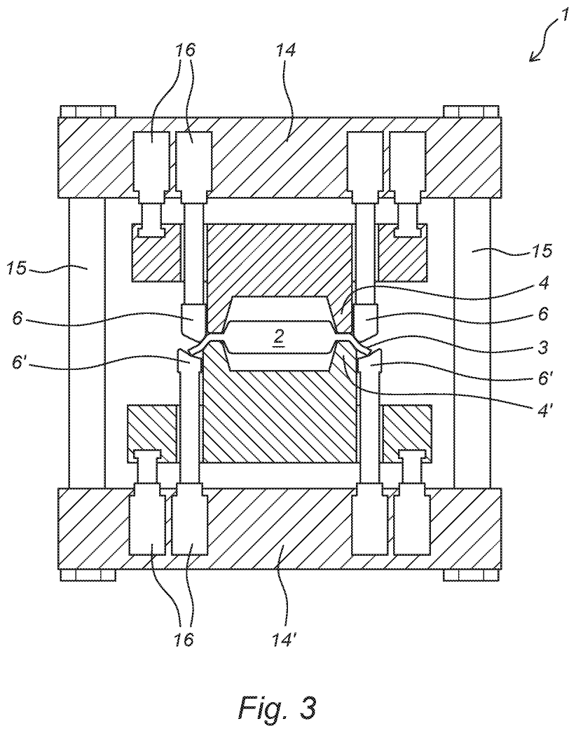

FIG. 3 shows a cross section of a lead forming device 1 for forming a lead 3 of an electronic component 2. The device comprises two cooperating opposite tool parts 14, 14′. The distance between the tool parts 14, 14′can be adjusted via the bars 15 and are relatively movable towards and away from each other. The lead forming device 1 comprises a first clamp half 4 movably attached to one of the tool parts 14 and a second clamp half 4′ movably attached to the opposite tool part 14′for clamping at least part of the lead 3. The cooperating tool parts 14, 14′and the clamp halves 4, 4′are all connected via drives 16, in the form of pistons 16. Two first forming punches 6 have moved downwards and have bent leads 3 on either side of the electronic component 2 downwards. The leads 3 have also been partly bent upwards, as the second forming punches 6′act as stoppers for the leads 3. The first forming punches 6 are movably connected to the upper tool part 14 and both second forming punches 6′are movably connected to the opposite lower tool part 14′. The drives 16 are arranged for independently controlling cooperative movement of the first 6 and second forming punches 6′and allow the leads 3 to be bent in a gullwing shape.

The verb “comprise” and its conjugations as used in this patent document a understood to mean not only “comprise”, but to also include the expressions of “contain”, “substantially contain”, “formed by” and conjugations thereof.

1. A lead forming device for forming an electronic component lead, comprising:
two cooperating opposite tool parts relatively movable towards and away from each other;
a first clamp half attached to one of the tool parts and a second clamp half attached to the opposite tool part for clamping at least part of the lead;
at least one first forming punch movably connected to one of the tool parts and at least one second forming punch movably connected to the opposite tool part; and
a drive arranged for independently controlling cooperative movement of the first and second forming punches,
wherein the at least one first forming punch and the at least one second forming punch are configured to consecutively bend the electronic component lead while the lead remains clamped by the first clamp half and the second clamp half.

2. (canceled)

3. (canceled)

4. The lead forming device according to claim 1, wherein the at least one first forming punch is arranged to bend at least part of a lead in one first direction; and wherein the at least one second forming punch is arranged to bend at least a part of the lead in one second opposite direction.

5. Th lead forming device according to claim 1, wherein the at least one first forming punch is located adjacent to the first clamp half, and
wherein the at least one second forming punch is located adjacent to the second clamp half and/or
wherein the at least one first forming punch comprises at least two forming punches located adjacent to each other and/or
wherein the first and second clamp halves are movable in a direction substantially parallel to a direction of cooperative movement of the first and second forming punches.

6-8. (canceled)

9. The lead forming device according to claim 1, wherein the at least one first forming punch comprises a convex bending surface and the at least one second forming punch comprises a concave bending surface or the other way around.

10. The lead forming device according to claim 1, comprising at least one trimming punch for trimming the lead.

11. The lead forming device according to claim 1, comprising at least one third forming punch movably attached to one of the tool parts for bending the lead.

12. The lead forming device according to any claim 1, wherein the first clamp half and the second clamp half each comprise an at least partially flat lead contacting surface and/or
wherein at least one of the first clamp half and the second clamp half is arranged to at least partially form the lead.

13. (canceled)

14. The lead forming device according to claim 1, wherein the first clamp half and the second clamp half are provided with multiple contact surfaces for clamping multiple leads and/or
wherein the first and/or second forming punches provided with multiple contact surfaces to bend multiple leads.

15. (canceled)

16. The lead forming device according to claim 1, wherein the first clamp half and the second clamp half are arranged to directly contact at least part of the electric component lead and/or
wherein at least part of a lead clamping surface of the second clamp half is located opposite at least part of the first forming punch forming a die-like surface and wherein another at least part of the lead clamping surface of the second clamp half is located opposite at least part of the first clamp half forming a clamp-like surface; and
wherein the die-like surface and the clamp-like surface are not located in a same plane.

17. (canceled)

18. A lead forming assembly comprising a lead forming device according to claim 1, wherein the lead forming device comprises:
a lead trimming and/or preforming section, comprising an upper trimming clamp half movably attached to the first tool part, a lower trimming clamp half movably attached to the second tool part, and the at least one trimming punch;
a lead forming section, comprising the first and second clamp halves and the at least one first and at least one second forming punches; and
a final forming section, comprising an upper final forming clamp movably attached to the first tool part, a lower final forming clamp movably attached to the second tool part, and the at least one third forming punch.

19. (canceled)

20. A method for forming an electronic component lead, comprising the following steps:
a) providing an electronic component comprising at least one lead;
b) clamping the at least one lead on opposite sides of the lead at a clamping location adjacent to the electronic component and away from a tip of the lead;
c) bending the lead in a first bending direction at a first bending location located between the clamping location and the tip of the lead; and
d) bending the lead in a second bending direction at a second bending location between the first bending location and the tip;
wherein steps c) and d) are performed subsequently.

21. The method according to claim 20, wherein the first bending direction is opposite to the second bending direction.

22. The method according to claim 20, wherein steps c) and d) are performed subsequently while the lead remains in a clamped position and/or
wherein prior to step b) the lead is cut and/or
wherein after step d) of the lead is further bent in the first bending direction.

23. (canceled)

24. (canceled)

25. The method according to claim 20, wherein during step c) the lead is bent around at least part of a surface of at least one clamp half clamping the at least one lead together with another clamp half at the clamping location and/or
wherein during step d) the lead is bent around a surface of a punch bending the lead in the first bending: direction at the first bending location.

26. (canceled)
